(19) United States
(12) Patent Application Publication
(10) Pub. No.: US 2026/0141867 A1
(43) Pub. Date: May 21, 2026

(54) DISPLAY APPARATUS

(71) Applicant: LG Display Co., Ltd., Seoul (KR)

(72) Inventors: Soon-Sung AHN, Paju-si (KR); Yang-Wan KIM, Paju-si (KR); Juhn-Suk YOO, Paju-si (KR); Jung-Chul KIM, Paju-si (KR); Chang-Heon KANG, Paju-si (KR)

(73) Assignee: LG Display Co., Ltd., Seoul (KR)

(21) Appl. No.: 19/344,856

(22) Filed: Sep. 30, 2025

(30) Foreign Application Priority Data
Nov. 19, 2024 (KR) 10-2024-0165139

(51) Int. Cl. G09G 3/3291; G09G 3/3266

(52) U.S. Cl. CPC G09G 3/3291; G09G 3/3266; G09G 2300/043; G09G 2300/0819; G09G 2310/0245; G09G 2310/0294; G09G 2310/08; G09G 2330/021

(57) ABSTRACT

A display apparatus can include a display panel having a display region in which pixels are arranged and a non-display region surrounding the display region, a data driving portion configured to apply data voltages to the pixels, and at least one gate driving portion configured to apply scan signals and emission control signals to the pixels. The pixel includes a light emitting element having an anode electrode, a cathode electrode, and a light emitting layer between the anode electrode and the cathode electrode, a driving transistor configured to supply a driving current to the light emitting element and including an oxide semiconductor layer, and a first capacitor and a second capacitor connected in series to a gate electrode of the driving transistor. The first capacitor is configured to store a threshold voltage of the driving transistor, and the second capacitor is configured to store the data voltage.

### CROSS REFERENCE TO RELATED APPLICATIONS

The present application claims priority to Korean Patent Application No. 10-2024-0165139, filed in the Republic of Korea on Nov. 19, 2024, which is hereby expressly incorporated by reference in its entirety for all purposes as if fully set forth herein.

### BACKGROUND

### Field of the Invention

The present disclosure relates to a display apparatus.

### Discussion of the Related Art

As the information society develops, a demand for display apparatuses for displaying images has increased in various forms. In recent years, various flat display apparatuses such as organic light emitting display apparatuses and liquid crystal display apparatuses have been used.

In the organic light emitting display apparatus, in order to compensate for a threshold voltage of a driving transistor, a threshold voltage sampling can be performed in a horizontal period when a data voltage is input.

In this case, since a sampling time for the threshold voltage compensation is insufficient, an error component in the sampled voltage can exist, and thus the threshold voltage compensation in a pixel may not be performed sufficiently.

When the error in threshold voltage compensation occurs, the image quality of the display apparatus is deteriorated.

### SUMMARY OF THE DISCLOSURE

An advantage of the present disclosure is to provide a display apparatus that can increase a threshold voltage sampling time of a driving transistor and improve a threshold voltage compensation.

Another object of the present disclosure is to provide a display apparatus which can address the limitations and disadvantages associated with the related art.

Additional features and advantages of the disclosure will be set forth in the description which follows, and in part will be apparent from the description, or can be learned by practice of the disclosure. These and other advantages of the disclosure will be realized and attained by the structure particularly pointed out in the written description and claims hereof as well as the appended drawings.

To achieve these and other advantages and in accordance with the purpose of the present disclosure, as embodied and broadly described herein, a display apparatus includes a display panel including a display region in which pixels are arranged and a non-display region surrounding the display region, a data driving portion configured to apply data voltages to the pixels, and at least one gate driving portion configured to apply scan signals and emission control signals to the pixels. One or each of the pixels can include a light emitting element including an anode electrode, a cathode electrode, and a light emitting layer between the anode electrode and the cathode electrode, a driving transistor configured to supply a driving current to the light emitting element and including an oxide semiconductor layer, and a first capacitor and a second capacitor connected in series to a gate electrode of the driving transistor, and wherein the first capacitor is configured to store a threshold voltage of the driving transistor, and the second capacitor is configured to store a corresponding data voltage.

It is to be understood that both the foregoing general description and the following detailed description are examples and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this disclosure, illustrate embodiments of the disclosure and together with the description serve to explain the principles of the disclosure. In the drawings:

FIG. 1 is a view schematically illustrating a display apparatus according to a first embodiment of the present disclosure;

FIG. 2 is a circuit view schematically illustrating a first example of a pixel according to the first embodiment of the present disclosure;

FIG. 3 is a view illustrating a configuration of a gate driving portion of the display apparatus according to the first embodiment of the present disclosure;

FIGS. 4A and 4B are timing charts schematically illustrating an example of driving signals for driving a pixel of a display apparatus according to the first embodiment of the present disclosure;

FIGS. 5A to 5F are views illustrating operating states of elements within a pixel in an initialization period, a sampling period, a data writing period, an emission period, and an anode reset period, in driving using the driving signals of FIGS. 4A and 4B according to the first embodiment of the present disclosure;

FIG. 6 is a cross-sectional view schematically illustrating an example of a cross-sectional structure of a display panel according to the first embodiment of the present disclosure. ;

FIG. 7 is a circuit view schematically illustrating a second example of the pixel of the display apparatus according to the first embodiment of the present disclosure;

FIG. 8A is a circuit view schematically illustrating a first example of a pixel of a display apparatus according to a second embodiment of the present disclosure;

FIG. 8B is a circuit view schematically illustrating a second example of the pixel of the display apparatus according to the second embodiment of the present disclosure;

FIG. 9A is a circuit view schematically illustrating a third example of the pixel of the display apparatus according to the second embodiment of the present disclosure;

FIG. 9B is a circuit view schematically illustrating a fourth example of the pixel of the display apparatus according to the second embodiment of the present disclosure;

FIG. 10 is a timing chart schematically illustrating an example of driving signals for driving a pixel of the display apparatus according to the second embodiment of the present disclosure; and

FIG. 11 is a circuit view schematically illustrating a pixel of a display apparatus according to a third embodiment of the present disclosure.

### DETAILED DESCRIPTION OF THE EMBODIMENTS

Advantages and features of the present disclosure and methods of achieving them will be apparent with reference to the embodiments described below in detail with the accompanying drawings. However, the present disclosure is not limited to the embodiments disclosed below, but can be realized in a variety of different forms, and only these embodiments allow the present disclosure to be complete. The present disclosure is provided to fully inform the scope of the disclosure to the skilled in the art of the present disclosure, and the present disclosure can be defined by the scope of the claims.

The shapes, sizes, proportions, angles, numbers, and the like disclosed in the drawings for explaining the embodiments of the present disclosure are illustrative, and the present disclosure is not limited to the illustrated matters. The same reference numerals refer to the same components throughout the description.

Furthermore, in describing the present disclosure, if it is determined that a detailed description of the related known technology unnecessarily obscure the subject matter of the present disclosure, the detailed description thereof can be omitted. When ‘comprising’, ‘including’, ‘having’, ‘consisting’, and the like are used in this disclosure, other parts can be added unless ‘only’ is used. When a component is expressed in the singular, cases including the plural are included unless specific statement is described.

In interpreting the components, even if there is no separate explicit description, it is interpreted as including a margin range.

In the case of a description of a positional relationship, for example, when the positional relationship of two parts is described as ‘on’, ‘over’, ‘above’, ‘below’, ‘beside’, ‘under’, and the like, one or more other parts can be positioned between such two parts unless ‘right’ or ‘directly’ is used.

In the case of a description of a temporal relationship, for example, when a temporal precedence is described as ‘after’, ‘following’, ‘before’, and the like, cases that are not continuous can be included unless ‘directly’ or ‘immediately’ is used.

In describing components of the present disclosure, terms such as first, second and the like can be used. These terms are only for distinguishing the components from other components, and an essence, order, sequence, or number of the components is not limited by the terms.

Respective features of various embodiments of the present disclosure can be partially or wholly connected to or combined with each other and can be technically interlocked and driven variously, and respective embodiments can be independently implemented from each other or can be implemented together with a related relationship. Further, the term “can” fully encompasses all the meanings and coverages of the term “may” and vice versa.

Hereinafter, embodiments of the present disclosure are described in detail with reference to the drawings. Meanwhile, in the following embodiments, the same and like reference numerals are assigned to the same and like components, and detailed descriptions thereof can be omitted or briefly provided. Here, all the components of each display apparatus/device according to all embodiments of the present disclosure are operatively coupled and configured.

### First Embodiment

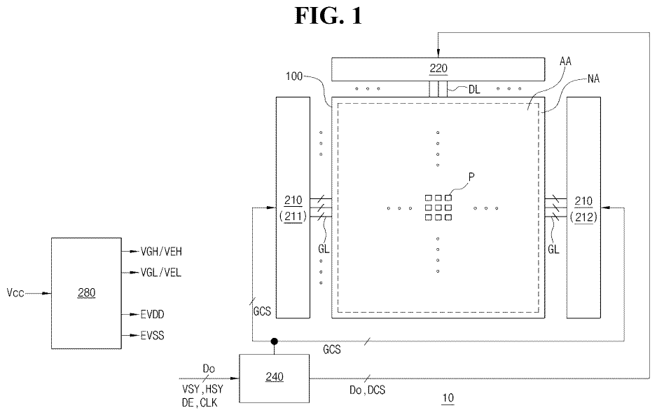

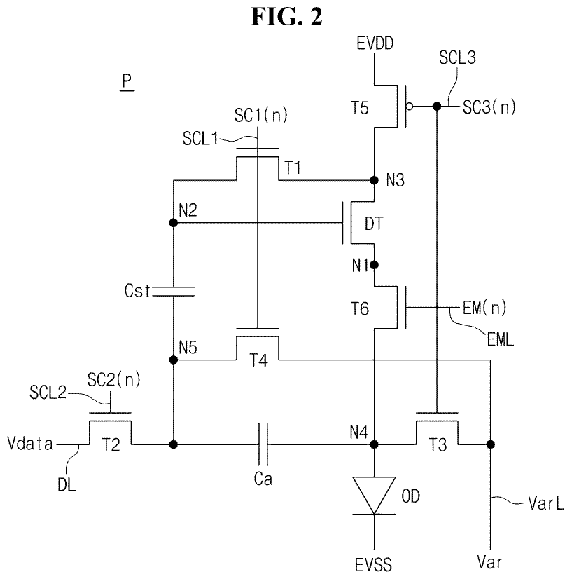

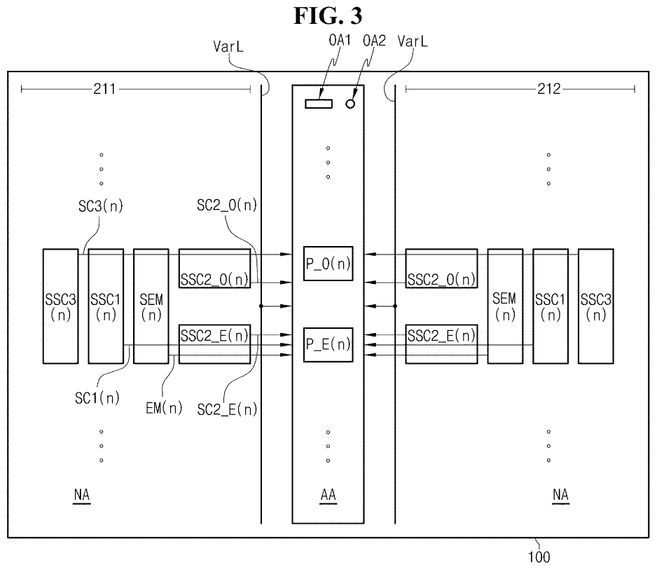

FIG. 1 is a view schematically illustrating a display apparatus according to a first embodiment of the present disclosure. FIG. 2 is a circuit view schematically illustrating a first example of a pixel of the display apparatus according to the first embodiment of the present disclosure. FIG. 3 is a view illustrating a configuration of a gate driving portion of the display apparatus according to the first embodiment of the present disclosure.

Prior to a specific description, a display apparatus 10 according to all embodiments of the present disclosure can include a light emitting display apparatus equipped with a light emitting diode. Furthermore, the display apparatus 10 according to all embodiments of the present disclosure can include all types of display apparatuses to which a VRR (variable refresh rate) method is applied.

Meanwhile, for convenience of explanation, in the embodiments of the present disclosure, an organic light emitting display apparatus is described as an example of the display apparatus 10.

Referring to FIGS. 1 to 3, the display apparatus 10 of this embodiment can include a display panel 100 and a driving circuit portion that drives the display panel 100.

Here, the driving circuit portion can include, for example, a gate driving portion (or gate driving circuit) 210, a data driving portion (or data driving circuit) 220, and a timing control portion (or timing control circuit) 240. In addition, the driving circuit portion can include a power supply portion (or power supply circuit) 280 that supplies power required for driving the display panel 100, the gate driving portion 210, the data driving portion 220, and the timing control portion 240.

The display panel 100 can include a display region (or active area) AA that displays an image, and a non-display region (or non-active area) NA arranged outside the display region AA (or surrounding the display region AA entirely or only in part(s)).

In the display region AA, a plurality of pixels (or subpixels) P can be arranged in a matrix form along a plurality of horizontal lines (or row lines) and a plurality of vertical lines (or column lines).

Here, the plurality of pixels P can include pixels that display different colors, for example, red, green, and blue pixels that display red, green, and blue, respectively, but not limited thereto.

In the display panel 100, various signal lines that transmit driving signals for driving the pixels P can be formed on a substrate.

In this regard, for example, a plurality of data lines DL that transmit data signals (or data voltages) which are image signals can extend in the vertical direction and be connected to the pixels P of the respective vertical lines.

In addition, a gate line GL that transmits a gate signal (or gate voltage) can extend in the horizontal direction and be connected to the pixel P of the corresponding horizontal line.

In this embodiment, a plurality of gate signals can be used to drive each pixel P, for example, a first scan signal SC1 to a third scan signal SC3, and an emission control signal EM can be used. Accordingly, a plurality of gate lines GL respectively transmitting the plurality of gate signals can be used, for example, a first scan line SCL1 to a third scan line SCL3, and an emission control line EML can be used.

As such, the plurality of pixels P can be defined by the plurality of data lines DL and gate lines GL intersecting each other.

Each pixel P can include a light emitting diode OD as a light emitting element, and a plurality of transistors and at least one capacitor for driving the light emitting diode OD.

Meanwhile, in this embodiment, for convenience of explanation, a 7T2C structure in which the pixel P is equipped with seven transistors T1 to T6 and DT and two capacitor Cst and Ca as illustrated in FIG. 2 is taken as an example.

Referring to FIG. 2, each pixel P can include a plurality of switching transistors, for example, first transistor T1 to sixth transistor T6, a driving transistor DT, a storage capacitor (or first capacitor) Cst, an auxiliary capacitor (or second capacitor) Ca, and the light emitting diode OD.

Each of the first to sixth transistors T1 to T6 and the driving transistor DT can include a first electrode, a second electrode, and a gate electrode. One of the first electrode and the second electrode can be a source electrode, and the other of the first electrode and the second electrode can be a drain electrode.

Each of the first to sixth transistors T1 to T6 and the driving transistor DT can be a P-type or N-type transistor. In this embodiment, as illustrated in FIG. 2, the case in which the first to fourth transistors T1 to T4, the sixth transistor T6, and the driving transistor DT among the thin film transistors configured in the pixel P, excluding the fifth transistor T5, are all configured as N-type transistors is taken as an example, but not limited thereto.

The first transistor T1 to the sixth transistor T6 and the driving transistor DT can include semiconductors of the same material or can include semiconductors of different materials. In this regard, for example, some of the first transistor T1 to the sixth transistor T6 and the driving transistors DT can have one semiconductor layer among a polycrystalline silicon layer, an oxide semiconductor layer, and an amorphous silicon layer, and another some of the first transistor T1 to the sixth transistor T6 and the driving transistors DT can have another semiconductor layer among a polycrystalline silicon layer, an oxide semiconductor layer, and an amorphous silicon layer.

Since an oxide semiconductor has excellent off-current characteristics and has characteristics suitable for a switching transistor, at least one of the first transistor T1 to the sixth transistor T6 can have an oxide semiconductor layer. In addition, since a polycrystalline silicon has excellent mobility, the driving transistor DT can have a polycrystalline silicon layer. In another form, the first transistor T1 to the sixth transistor T6 and the driving transistor DT can be configured, for example, the driving transistor DT can have an oxide semiconductor layer.

In this embodiment, a case where at least some of the first to sixth transistors T1 to T6 include a polycrystalline silicon layer, and the driving transistor DT includes an oxide semiconductor layer is taken as an example.

The gate signals provided to a n-th horizontal line of FIG. 2 (more specifically, at least one of an odd horizontal line and an even horizontal line constituting the n-th horizontal line) can be provided from a corresponding n-th stage of the gate driving portion 210. For example, three scan signals, first to third scan signals (SC1 to SC3: SC1(n) to SC3(n)) and an emission control signal (EM: EM(n)) can be provided. Here, n can be a real number such as a positive integer. In this case, in the display region AA, first to third scan lines SCL1 to SCL3 and an emission control line EML that are connected to the n-th stage and transmit the first to third scan signals SC1(n) to SC3(n) and the emission control signal EM(n) to the pixel P can be arranged.

The first transistor T1 can function as a sampling transistor, the second transistor T2 can function as a data supply transistor, the third transistor T3 can function as a first reset transistor, the fourth transistor T4 can function as a second reset transistor, and the fifth and sixth transistors T5 and T6 can function as emission control transistors.

The light emitting diode OD can include an anode electrode and a cathode electrode. The anode electrode of the light emitting diode OD can be connected to a fourth node N4, and the cathode electrode of the light emitting diode OD can be applied with a low-potential driving voltage EVSS.

The driving transistor DT can include, for example, a first electrode (or source electrode) connected to a first node N1, a second electrode (or drain electrode) connected to a third node N3, and a gate electrode connected to a second node N2. The driving transistor DT can provide a driving current to the light emitting diode OD based on a voltage of the second node N2 (i.e., the data voltage Vdata stored in the storage capacitor Cst).

The first transistor T1 can include, for example, a first electrode (or source electrode) connected to the second node N2, a second electrode (or drain electrode) connected to the third node N3, and a gate electrode receiving the first scan signal SC1(n).

The first transistor T1 can be turned on in response to the first scan signal SC1(n), and a high-potential driving voltage EVDD can be applied (or written) to the storage capacitor Cst during an initialization period which is a horizontal period of the horizontal line on which the corresponding pixel P is arranged.

Moreover, the first transistor T1 can be turned on in response to the first scan signal SC1(n), and a threshold voltage (Vth) of the driving transistor DT can be applied (or sampled) to the gate electrode of the driving transistor DT during a sampling period set prior to a data writing period of the horizontal line on which the corresponding pixel P is arranged.

The storage capacitor Cst can be connected, for example, between the second node N2 and a fifth node N5. In other words, the storage capacitor Cst can be connected between the first electrode and the gate electrode of the driving transistor DT. For example, first and second electrodes forming the storage capacitor Cst can be connected to the second and fifth nodes N2 and N5, respectively.

The storage capacitor Cst can store and maintain the threshold voltage (Vth) of the driving transistor DT.

The second transistor T2 can include, for example, a second electrode (or drain electrode) connected to the data line DL (or receiving the data voltage Vdata), a first electrode (or source electrode) connected to the fifth node N5, and a gate electrode receiving the second scan signal SC2(n). The second transistor T2 can be turned on in response to the second scan signal SC2(n), and can transmit the data voltage Vdata to the fifth node N5.

The third transistor T3 can include, for example, a second electrode (or drain electrode) connected to a reset voltage line VarL transmitting an anode reset voltage Var, a first electrode (or source electrode) connected to the fourth node N4, and a gate electrode receiving the third scan signal SC3(n).

The third transistor T3 can be turned on in response to the third scan signal SC3(n), and the anode reset voltage Var can be applied to the fourth node N4 (i.e., the anode electrode of the light emitting diode OD) during a portion of the initialization period set prior to a sampling period of the corresponding pixel P, and during the sampling period and the data writing period.

In addition, the third transistor T3 can be turned on in response to the third scan signal SC3(n), and the anode reset voltage Var together with the threshold voltage (Vth) can be applied (or sampled) to the gate electrode of the driving transistor DT during the sampling period of the corresponding pixel P.

The fourth transistor T4 can be, for example, connected to the second transistor T2 at the fifth node N5, so that the fourth transistor T4 and the second transistor T2 can have a parallel connection relationship.

The fourth transistor T4 can include, for example, a second electrode (or drain electrode) connected to the reset voltage line VarL that transmits the anode reset voltage Var, a first electrode (or source electrode) connected to the fifth node N5, and a gate electrode that receives the first scan signal SC1(n).

The fourth transistor T4 together with the first transistor T1 can be turned on in response to the first scan signal SC1(n), and the anode reset voltage Var can be applied to the fifth node N5 during the initialization period and the sampling period set prior to the data writing period of the corresponding pixel P.

The fifth transistor T5 can include, for example, a second electrode (or drain electrode) receiving the high-potential driving voltage EVDD, a first electrode (or source electrode) connected to the third node N3, and a gate electrode receiving the third scan signal SC3(n).

The fifth transistor T5 together with the third transistor T3 can be controlled in response to the third scan signal SC3(n), and can connect the high-potential driving voltage EVDD to the second electrode of the driving transistor DT during an emission period to provide a driving current to the light emitting diode OD.

Since the fifth transistor T5 can be configured as a P-type transistor, it can operate in the opposite manner to the third transistor T3 configured as an N-type transistor. In other words, when the third transistor T3 is turned on, the fifth transistor T5 can be turned off, and when the third transistor T3 is turned off, the fifth transistor T5 can be turned on.

The sixth transistor T6 can include, for example, a second electrode (or drain electrode) connected to the first node N1 (or the first electrode of the driving transistor DT), a first electrode (or source electrode) connected to the fourth node N4, and a gate electrode that receives the emission control signal EM(n).

The sixth transistor T6 can be turned on in response to the emission control signal EM(n), and a driving current can be supplied to the light emitting diode OD during the emission period set after the data writing period of the corresponding pixel P, and the light emitting diode OD can emit light with a luminance corresponding to the driving current.

In addition, the sixth transistor T6 directly connected to the driving transistor DT can be turned on in response to the emission control signal EM(n), and can form a current path (or charge path) for sampling the threshold voltage (Vth) at the second node N2 together with the first transistor T1 during the sampling period of the corresponding pixel P.

In this regard, during the sampling period for sampling the threshold voltage (Vth) of the driving transistor DT, as previously mentioned, the first transistor T1, the third transistor T3, and the sixth transistor T6 can be turned on.

In this case, a current path can be formed along the third transistor T3, the driving transistor DT, the sixth transistor T6, and the first transistor T1. Accordingly, a voltage (Var +Vth), which reflects the anode reset voltage Var input through the third transistor T3 and the threshold voltage (Vth) of the driving transistor DT, can be applied to the second node N2 to which the gate electrode of the driving transistor DT is connected.

The auxiliary capacitor Ca can be connected, for example, between the fourth node N4 and the fifth node N5. In other words, the auxiliary capacitor Ca can be connected between the first electrodes (or source electrodes), which are output electrodes of the second and fourth transistors T2 and T4, and the fourth node N4. For example, third and fourth electrodes forming the auxiliary capacitor Ca can be connected to the fourth and fifth nodes N4 and N5, respectively.

During the data writing period, the data voltage Vdata input to the fifth node N5 can be reflected to the second node N2 through the series-connected storage capacitor Cst and auxiliary capacitor Ca.

For example, during the initialization and sampling periods, the anode reset voltage Var can be input to the fifth node N5, and then, during the data writing period, the data voltage Vdata can be input to the fifth node N5 and the anode reset voltage Var can be input to the fourth node (N4), so that a difference between these voltages (ΔV=Vdata−Var) can be stored in the auxiliary capacitor Ca.

At this time, the series-connected storage capacitor Cst and auxiliary capacitor Ca can be a path between the gate electrode and the first electrode (or source electrode) of the driving transistor DT, and a sum of the voltages stored in the storage capacitor Cst and auxiliary capacitor Ca can be a voltage difference between the gate electrode and the first electrode (or source electrode) of the driving transistor DT.

As such, during the data writing period, the voltage difference (ΔV) including the data voltage Vdata can be reflected to the second node N2 through the storage capacitor Cst and the auxiliary capacitor Ca. Thus, the data voltage Vdata can be reflected to the gate electrode of the driving transistor DT.

As such, the pixel P of this embodiment can perform the sampling operation of the threshold voltage (Vth) of the driving transistor DT before the data writing operation.

As such, in this embodiment, the sampling operation for threshold voltage (Vth) compensation can be performed separately from the data writing operation. Accordingly, the sampling time of the threshold voltage (Vth) is not limited to the horizontal period when the data writing is performed, but can be set longer than the horizontal period.

By enabling the sampling operation for a long time, the threshold voltage (Vth) can be sufficiently sampled and reflected, reducing or preventing an error component in the sampled voltage.

Accordingly, the threshold voltage compensation of the pixel P can be improved, and thus a compensation error can be reduced, and as a result, the image quality of the display apparatus 10 can be improved.

The driving method for implementing the threshold voltage compensation of this embodiment can be described in more detail below.

Referring to FIG. 1, the timing control portion 240 can process image data Do input from a host system to be suitable for size and resolution of the display panel 100 and supply them to the data driving portion 220. The timing control portion 240 can generate a gate control signal GCS and a data control signal DCS using synchronization signals input from the host system, for example, a dot clock signal CLK, a data enable signal DE, a horizontal synchronization signal HSY, and a vertical synchronization signal VSY. By supplying the gate control signal GCS and the data control signal DCS generated in this way to the gate driving portion 210 and the data driving portion 220, respectively, the gate driving portion 210 and the data driving portion 220 can be controlled.

The timing control portion 240 can be configured to be combined with various processors, for example, a microprocessor, a mobile processor, an application processor, etc., depending on a device to be mounted.

The host system can be, for example, a driving system that drives an electronic device to which the display apparatus 10 is applied. The electronic device can be, for example, one of a TV (Television), a navigation system, a monitor, a mobile device, and a wearable device.

The gate driving portion 210 can receive the gate control signal GCS from the timing control portion 240, generate the gate signals, and sequentially apply the gate signals to the gate lines GL. For example, the gate signals can be sequentially output from the top to the bottom in the vertical direction.

The gate driving portion 210 can be arranged, for example, on at least one side of the display region AA. In this embodiment, a case is taken as an example in which the gate driving portion 210 is configured to include first and second gate driving portions 211 and 212 arranged on both sides of the display region AA, for example, on the left and right sides of the display region AA.

The gate driving portion 210 can be formed directly in the non-display region NA on the substrate of the display panel 100, for example, in a GIP (gate-in panel) structure. In this case, the gate driving portion 210 can be formed during processes of forming elements of the display panel 100.

The gate driving portion 210 configured with the GIP structure can include, for example, a first scan driving circuit that sequentially outputs the first scan signals SC1, a second scan driving circuit that sequentially outputs the second scan signals SC2, a third scan driving circuit that sequentially outputs the third scan signals SC3, an emission driving circuit that sequentially outputs the emission control signals EM.

Each of the first scan driving circuit to the third scan driving circuit and the emission driving circuits can be configured with a shift register including a plurality of stages that output respective signals.

The gate driving portion 210 is described with further reference to FIG. 3. FIG. 3 illustrates a part of the gate driving portion 210, and for convenience of explanation, a configuration of a portion of the gate driving portion 210 that drives the n-th horizontal line configured with a n-th odd horizontal line (or 2n−1-th horizontal line) and a n-th even horizontal line (or 2n-th horizontal line) of the display region AA is illustrated.

In the first gate driving portion 211 of the gate driving portion 210, for example, first and third scan stages SSC1(n) and SSC3(n) that constitute the first and third scan driving circuits, respectively, an emission stage SEM(n) that constitute the emission driving circuit, and odd and even second scan stages SSC2_O(n) and SSC2_E(n) that constitute the second scan driving circuit can be arranged.

In addition, in the second gate driving portion 212 of the gate driving portion 210, for example, first and third scan stages SSC1(n) and SSC3(n) that constitute the first and third scan driving circuits, respectively, an emission stage SEM(n) that constitute the emission driving circuit, and odd and even second scan stages SSC2_O(n) and SSC2_E(n) that constitute the second scan driving circuit can be arranged.

In the gate driving portion 210, the odd and even second scan stages SSC2_O(n) and SSC2_E(n) constituting the second scan driving circuit can be arranged so as to be closest to the display region AA, and the emission stage SEM(n) can be arranged between the first to third scan stages SSC1(n) to SSC3(n). However, without limitation to this arrangement, the emission stage SEM(n) can be positioned at the outermost side furthest from the display region AA.

The arrangement of the first to third scan stages SSC1(n) to SSC3(n) and the emission stage SEM(n) shown in FIG. 3 is an example, and they can be arranged in various combinations in the first and second gate driving portions 211 and 212.

The first scan stage SSC1(n) can generate the first scan signal SC1(n) and output it to the corresponding first scan line SCL1. Accordingly, the pixel P_O(n) of the n-th odd horizontal line and the pixel P_E(n) of the n-th even horizontal line can be commonly applied with the first scan signal SC1(n).

The odd second scan stage SSC2_O(n) can generate an odd second scan signal SC2_O(n) and output it to the corresponding odd second scan line SCL2, and the even second scan stage SSC2_E(n) can generate an even second scan signal SC2_E(n) and output it to the corresponding even second scan line SCL2. Accordingly, the pixel P_O(n) of the n-th odd horizontal line can be applied with the odd second scan signal SC2_O(n), and the pixel P_E(n) of the n-th even horizontal line can be applied with the even second scan signal SC2_E(n). Here, the odd second scan signal SC2_O(n) and the even second scan signal SC2_E(n) can have different timings. For example, the odd second scan signal SC2_O(n) and the even second scan signal SC2_E(n) can be applied to a horizontal period (or data writing period) of the n-th odd horizontal line and a horizontal period (or data writing period) of the n-th even horizontal line immediately following it, respectively.

The third scan stage SSC3(n) can generate the third scan signal SC3(n) and output it to the corresponding third scan line SCL3. Accordingly, the pixels P_O(n) and P_E(n) of the n-th odd and even horizontal lines can be commonly applied with the third scan signal SC3(n).

The emission stage SEM(n) can generate the emission control signal EM(n) and output it to the corresponding emission control line EML. Accordingly, the pixels P_O(n) and P_E(n) of the n-th odd and even horizontal lines can be commonly applied with the emission control signal EM(n).

Referring to FIG. 3, the reset voltage line VarL can be arranged between the gate driving portion 210 and the display region AA.

The reset voltage line VarL can supply the anode reset voltage Var from the power supply portion 280 to the pixels P within the display region AA.

The reset voltage line VarL is illustrated as being located on both sides of the display region AA, but not limited thereto, and the reset voltage line VarL can be located on one side of the display region AA, and even if located on one side, the location on the left or right side is not limited.

One or more optical regions OA1 and OA2 can be disposed in the display region AA.

The one or more optical regions OA1 and OA2 can be arranged to overlap one or more optical electronic devices, for example, a photographing device such as a camera (or image sensor), and/or a detection sensor such as a proximity sensor and an illuminance sensor. For the operation of the optical electronic device, the one or more optical regions OA1 and OA2 can have a light-transmitting structure formed therein and can have transmittance of a certain level or higher. In other words, a number of pixels P per unit area in the one or more optical regions OA1 and OA2 can be smaller than a number of pixels P per unit area in a regular region excluding the optical regions OA1 and OA2 in the display region AA. For example, a resolution of the one or more optical regions OA1 and OA2 can be lower than a resolution of the regular region within the display region AA.

Referring back to FIG. 1, the data driving portion 220 can receive the image data Do and the data control signal DCS from the timing control portion 240, and in response to the data control signal DCS, the data driving portion 220 can convert the image data Do into analog image data i.e., data voltages Vdata, and outputs them to the respective data lines DL.

The power supply portion 280 can generate DC power required for driving the pixel array and the driving circuit portion of the display panel 100 using, for example, a DC-DC converter. The DC-DC converter can include a charge pump, a regulator, a buck converter, a boost converter, etc.

The power supply portion 280 can receive, for example, a power voltage Vcc that is a driving voltage for driving the display apparatus (10) from the host system, and generate the DC voltages such as the gate low voltages VGL and VEL, the gate high voltages VGH and VEH, the high-potential driving voltage EVDD, and the low-potential driving voltage EVSS. The gate low voltages VGL and VEL and the gate high voltages VGH and VEH can be supplied to the gate driving portion 210. The high-potential driving voltage EVDD and the low-potential driving voltage EVSS can be supplied in common to the pixels P in the display panel 100.

The display apparatus 10 of this embodiment configured as above can be driven at low power in the VRR method in which a refresh cycle (or refresh rate) is adjusted, in order to reduce power consumption.

In this regard, in a normal driving mode which is a high-speed driving mode, the display apparatus 10 can operate to refresh (or update) an image of the display panel 100 (or the data voltage Vdata applied to each pixel P) by frame. For example, in the high-speed driving mode, the display apparatus 10 can be driven at a refresh rate of 120 Hz, so that a refresh operation can be performed for each of 120 frames per second. In this way, in the high-speed driving mode, all frames can be assigned as refresh frames in which the data voltage Vdata is written.

In the case of displaying a still image, etc., the display apparatus 10 can be driven in a low-speed driving mode. In the low-speed driving mode, the refresh rate is reduced, so that the refresh cycle of the display panel 100 becomes longer. For example, in the case of low-speed driving with a refresh rate of 10 Hz, one refresh frame and 11 consecutive skip frames can be alternately repeated. As such, in the low-speed driving mode, the frames can be divided into the refresh frame in which the data voltage Vdata is written and the skip frame in which the data voltage Vdata is not written and the writing is skipped.

As such, in the low-speed driving mode, as the driving frequency decreases, the cycle of the refresh frame (or the interval between the refresh frames) becomes longer, and one or more skip frames exist between the refresh frames.

During the skip frame, the image refresh operation is stopped, so that power consumption can be reduced.

In the refresh frame when the data voltage Vdata is written, the first scan signal SC1 to the third scan signal SC3 (more specifically, their scan pulses) can be applied in order to write the data voltage Vdata to the corresponding pixel P.

In addition, in the skip frame when the data voltage Vdata is not written and maintained, an operation of applying the anode reset voltage Var to reset the anode electrode of the light emitting diode OD can be performed. To this end, the third scan signal SC3 (more specifically, its scan pulse) for providing the anode reset voltage Var to the pixel P can be applied.

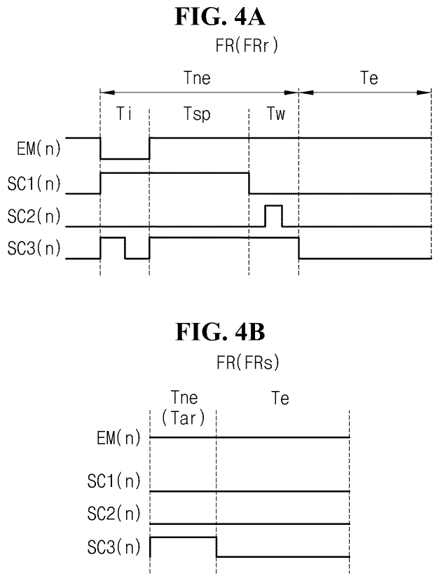

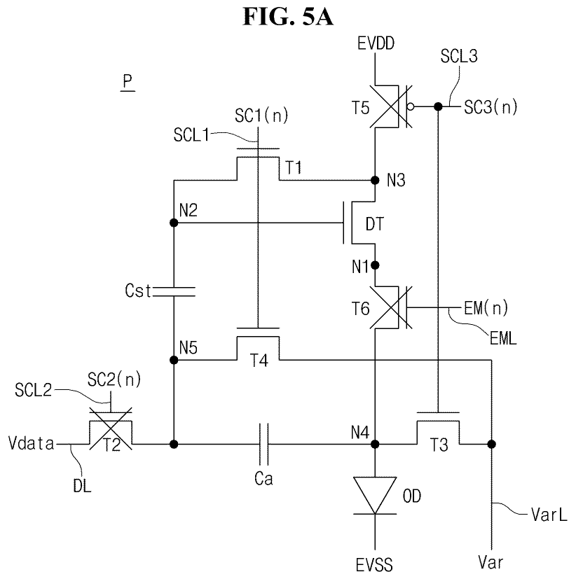

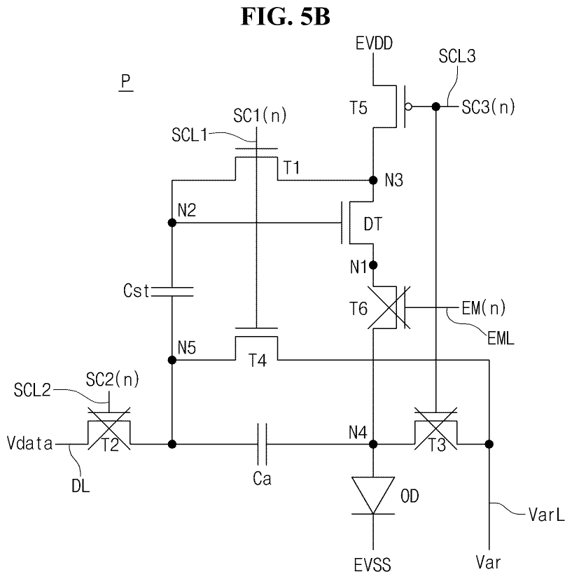

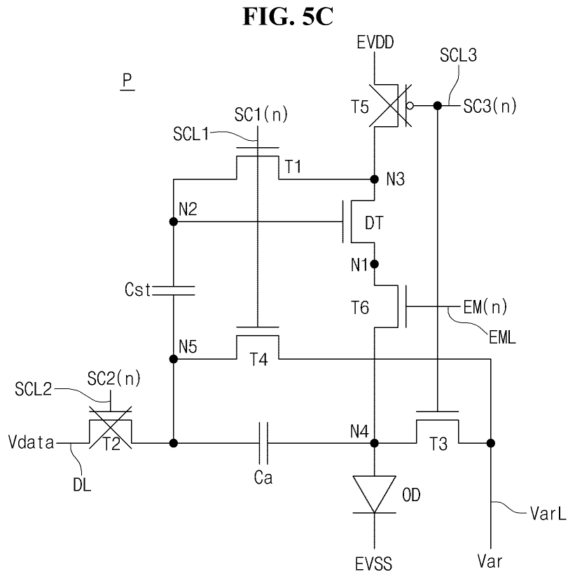

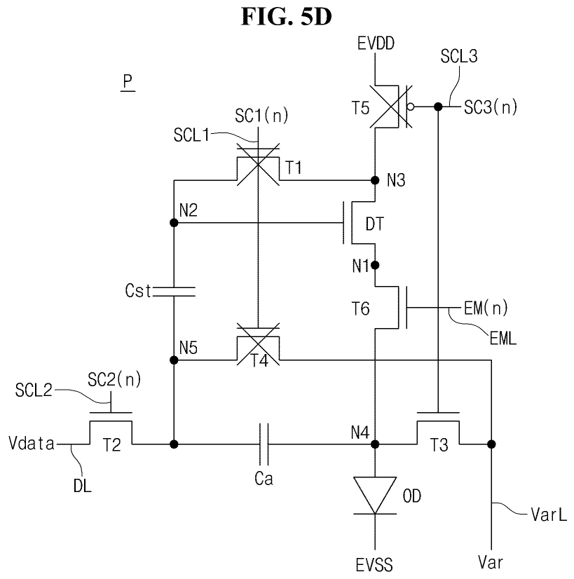

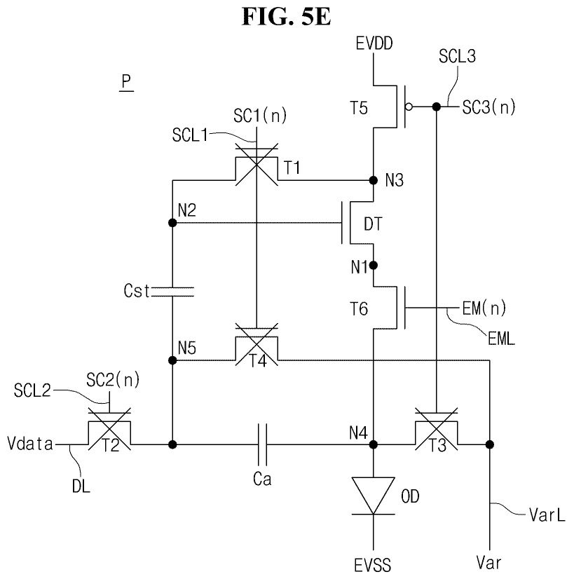

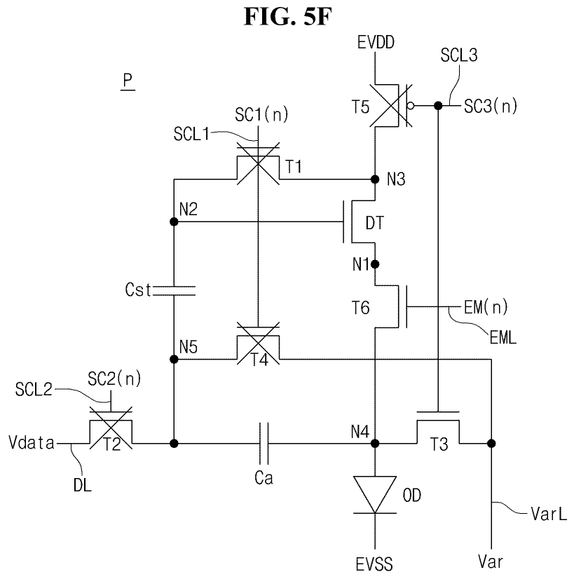

Hereinafter, the driving in the refresh frame in which the data voltage Vdata is written and the threshold voltage (Vth) of the driving transistor DT is sampled and compensated is described with further reference to FIGS. 4A and 4B, and 5A and 5B.

FIGS. 4A and 4B are timing charts schematically illustrating an example of driving signals for driving a pixel of the display apparatus according to the first embodiment of the present disclosure. FIGS. 5A to 5F are views illustrating operating states of elements within a pixel in an initialization period, a sampling period, a data writing period, an emission period, and an anode reset period, in driving using the driving signals of FIGS. 4A and 4B.

In FIGS. 4A and 4B and FIGS. 5A to 5F, for convenience of explanation, the driving of the pixel P_O(n) of an odd horizontal line among the pixels P of the n-th horizontal line is illustrated as an example. To the pixel P_E(n) of the n-th even horizontal line, the corresponding second scan signal SC2_E(n) can be applied during the corresponding horizontal period.

First, referring to FIG. 4A, the driving in the refresh frame FRr that is the frame FR in which the refresh operation is performed is described. The refresh frame FRr can be divided into a non-emission period Tne and an emission period Te.

The non-emission period Tne and the emission period Te can be defined by the emission control signal EM(n) and the third scan signal SC3(n) of the refresh frame FRr. In this regard, for example, a section in which both the emission control signal EM(n) and the third scan signal SC3(n) are at the turn-on level can correspond to the emission period (Te), and a section in which at least one of the emission control signal EM(n) and the third scan signal SC3(n) is at the turn-off level can correspond to the non-emission period Tne. In other words, the turn-on level of the emission control signal EM(n) can be a high level, and the turn-on level of the third scan signal SC3(n) can be a low level.

The non-emission period Tne can be substantially a period in which the scan signals SC1(n) to SC3(n) are applied and a data refresh operation is performed, and can be said to correspond to a data refresh period or a scan driving period.

Within the non-emission period Tne of the refresh frame FRr, for example, an initialization period Ti, a sampling period Tsp, and a data writing period Tw can be sequentially performed.

Next, referring to FIG. 4B, the skip frame FRs that is the frame FR in which an anode reset operation is performed can be divided into a non-emission period Tne and an emission period Te, similar to the refresh frame FRr. The non-emission period Tne can be an anode reset period Tar.

The skip frame FRs can be operated in a low-speed driving mode, and in a normal driving mode as a high-speed normal driving mode, only the refresh frame FRr can be operated without the skip frame FRs.

Regarding the initialization period Ti, referring to FIGS. 4A, 5A, and 5B, for example, the first scan signal SC1(n) can have a high level, the second scan signal SC2(n) can have a low level, and the emission control signal EM(n) can have a low level.

In addition, during the initialization period Ti, the third scan signal SC3(n) can first be supplied at a high level and then changed to a low level.

In response to the scan signals SC1(n) to SC3(n) and the emission control signal EM(n), the first transistor T1, the fourth transistor T4, and the third transistor T3 can be turned on, and the second transistor T2, the fifth transistor T5, and the sixth transistor T6 can be turned off.

Accordingly, by the third and fourth transistors T3 and T4 that are turned on, the anode reset voltage Var can be provided to the fourth and fifth nodes N4 and N5. As a result, voltages of both ends of the auxiliary capacitor Ca can be initialized to the anode reset voltages Var, and thus, voltages stored in the auxiliary capacitor Ca can be initialized.

Next, as the third scan signal SC3(n) changes from the high level to the low level, the third transistor T3 can be turned off, and the fifth transistor T5 can be turned on.

Accordingly, by the first and fifth transistors T1 and T5 in the turned-on state, the high-potential driving voltage EVDD can be provided to the second and third nodes N2 and N3, and the anode reset voltage Var can be provided to the fifth node N5 through the fourth transistor T4 in the turned-on state. As a result, a voltage of the gate electrode of the driving transistor DT can be initialized, and a voltage corresponding to the difference between the high-potential driving voltage EVDD and the anode reset voltage Var can be stored in the storage capacitor Cst.

Next, regarding the sampling period Tsp performed after the initialization period Ti, referring to FIGS. 4A and 5C, for example, the first scan signal SC1(n) can have a high level, and the third scan signal SC3(n) can have a high level.

During the sampling period Tsp, the second scan signal SC2(n) can have a low level, and the emission control signal EM(n) can have a high level.

In response to the scan signals SC1(n) to SC3(n) and the emission control signal EM(n), the first transistor T1, the third transistor T3, the fourth transistor T4, and the sixth transistor T6 can be turned on, and the second transistor T2 and the fifth transistor T5 can be turned off.

Accordingly, by the first transistor T1 in the turned-on state, the third node N3 to which the second electrode of the driving transistor DT is connected and the second node N2 to which the gate electrode of the driving transistor DT is connected can be electrically short-circuited. Thus, the driving transistor DT can be in a diode-connection state in which the gate electrode and the drain electrode of the driving transistor DT are electrically short-circuited.

At this time, the third and sixth transistors T3 and T6 can be turned on, so that a current path can be formed along the third transistor T3, the driving transistor DT, the sixth transistor T6, and the first transistor T1. In addition, the storage capacitor Cst stores the voltage corresponding to the difference between the high-potential driving voltage EVDD and the anode reset voltage Var during the initialization period Ti, and the stored voltage can have a level sufficiently greater than the anode reset voltage Var applied to the first electrode (or source electrode) of the driving transistor DT, so that the stored voltage can be supplied to the gate electrode of the driving transistor DT at the beginning of the sampling period Tsp to turn on the driving transistor DT.

Accordingly, as the sampling period Tsp progresses, the voltage at the second node N2 to which the gate electrode of the driving transistor DT is connected can converge to (Var +Vth) which is a voltage that reflects the anode reset voltage Var input through the third transistor T3 and the threshold voltage (Vth) of the driving transistor DT.

In addition, one end of the storage capacitor Cst can be connected to the second node N2, and the other end of the storage capacitor Cst can be connected to the fifth node N5, so that the anode reset voltage Var can be applied through the fourth transistor T4 that is turned on.

Therefore, during the sampling period Tsp, according to the difference between the voltages supplied to the second node N2 and the fifth node N5, the threshold voltage (Vth) of the driving transistor DT can be charged and stored in the storage capacitor Cst.

As such, the sampling period Tsp when the threshold voltage Vth is reflected in the second node N2 can be set longer than the data writing period Tw set as the horizontal period, and preferably can be set to be equal to or more than twice the horizontal period.

As such, when the sampling period Tsp can be set to a considerably long time, separated from the data writing period Tw, the threshold voltage (Vth) of the driving transistor DT can be sufficiently sampled during the sampling operation.

Accordingly, an error component of the threshold voltage (Vth) that can occur when sampling for a short time, such as a horizontal period, can be reduced or prevented, thereby reducing a threshold voltage compensation error and enhancing a threshold voltage compensation, resulting in improved image quality of the display apparatus 10.

Meanwhile, in the sampling period Tsp, the anode reset voltage Var can be provided to the fourth node N4 by the turned-on third transistor T3, allowing the initialization i.e., the anode reset of the anode electrode of the light emitting diode OD to be performed.

Next, regarding the data writing period Tw performed after the sampling period Tsp, referring to FIGS. 4A and 5D, for example, the first scan signal SC1(n) can have a low level, the second scan signal SC2(n) can have a high level, and the third scan signal SC3(n) can have a high level.

During the data writing period Tw, the emission control signal EM(n) can have a high level.

In response to the scan signals SC1(n) to SC3(n) and the emission control signal EM(n), the second transistor T2, the third transistor T3, and the sixth transistor T6 can be turned on, and the first transistor T1, the fourth transistor T4, and the fifth transistor T5 can be turned off.

Accordingly, during the data writing period Tw, the data voltage Vdata can be provided to the fifth node N5 by the second transistor T2 that is turned on, and the anode reset voltage Var can be applied to the fourth node N4 by the third transistor T3 that is turned on.

At this time, the voltage difference from the second node N2, which the gate electrode of the driving transistor DT is connected to, to the anode electrode of the light emitting diode OD, which the first electrode (or source electrode) of the driving transistor DT is connected to, can be expressed as a voltage difference (Vgs) between the gate electrode and the first electrode (or source electrode) of the driving transistor DT.

In other words, the voltage difference (Vgs) between the gate electrode and the first electrode (or source electrode) of the driving transistor DT can be expressed as the sum of the voltages stored in the storage capacitor Cst and the auxiliary capacitor Ca which are series-connected to each other. In other words, the storage capacitor Cst can store a voltage corresponding to the threshold voltage (Vth) of the driving transistor DT, and the auxiliary capacitor Ca can store a voltage corresponding to the difference between the data voltage Vdata applied to the fifth node N5 and the anode reset voltage Var applied to the fourth node N4, so it can be expressed as a following formula.

Formula: Vgs=Vth+Vdata−Var.

As such, through the series-connection structure between the storage capacitor Cst, where the threshold voltage (Vth) of the driving transistor DT is stored, and the auxiliary capacitor Ca where the data voltage Vdata is applied, a more accurate compensation value can be derived.

Meanwhile, even during the data writing period Tw, the anode reset voltage Var can be continuously supplied to the first node N1 by the turned-on third transistor T3 and sixth transistor T6, thereby initializing the current path (or charge path) from the first electrode (or source electrode) of the driving transistor DT to the anode electrode of the light emitting diode OD, i.e., performing the anode reset.

At this time, during the initialization period Ti, the sampling period Tsp, and the data writing period Tw, at least one of the fifth and sixth transistors T5 and T6 can be turned off, and a connection between the light emitting diode OD and a terminal of the high-potential driving voltage EVDD can be electrically disconnected, so that no current path is formed, and thus the light emitting diode OD can be turned off.

As such, by continuously performing the anode reset operation during the initialization period Ti, the sampling period Tsp, and the data writing period Tw before the emission operation, the voltage of the fourth node N4 to which the anode electrode of the light emitting diode OD is connected can be stably maintained at the anode reset voltage Var before the emission operation. Accordingly, the light emitting diode OD can emit light normally during the emission period Te.

Meanwhile, regarding the data writing operation of the n-th odd and even horizontal lines, immediately after the data writing period Tw for the pixel P_O(n) of the n-th odd horizontal line is performed during the corresponding horizontal period, the data writing period Tw for the pixel P_E(n) of the n-th even horizontal line can be performed during the corresponding horizontal period.

As described above, after the data writing period Tw is completed, a driving current can be supplied to the light emitting diode OD during the emission period Te to perform the emission operation.

Regarding the emission period Te, referring to FIGS. 4A and 5E, for example, the first scan signal SC1(n) to the third scan signal SC3(n) can all have a low level, and the emission control signal EM(n) can have a high level.

In response to the scan signals SC1(n) to SC3(n) and the emission control signal EM(n), the first transistor T1 to the fourth transistor T4 can all be turned off, and the fifth and sixth transistors T5 and T6 can all be turned on.

Accordingly, by the turned-on fifth and sixth transistors T5 and T6, a current path can be formed from a terminal of the high-potential driving voltage EVDD to a terminal of the low-potential driving voltage EVSS. At this time, the driving transistor DT can be turned on according to the voltage of the second node N2 i.e., the gate electrode of the driving transistor DT to which the data voltage Vdata is reflected, so that the driving current corresponding to the data voltage Vdata can be provided to the light emitting diode OD, and the light emitting diode OD can emit light.

Here, as mentioned above, before the data writing period Tw, the sampling period Tsp can be set to a time longer than the horizontal period, so that the threshold voltage (Vth) can be sufficiently sampled and reflected into the voltage of the gate electrode of the driving transistor DT, so that the error component of the threshold voltage (Vth) can be reduced or prevented.

Accordingly, the influence of the error component of the threshold voltage (Vth) on the driving current generated in the emission period Te can be reduced or eliminated, so that the driving current with improved compensation for the threshold voltage can be provided to the light emitting diode OD.

As such, by improving the threshold voltage compensation, emission characteristics of the light-emitting diode OD can be improved, and the image quality characteristics of the display apparatus 10 can be enhanced.

Regarding the anode reset period Tar in the skip frame FRs, referring to FIGS. 4B and 5F, for example, the first scan signal SC1(n) can have a low level, the second scan signal SC2(n) can have a low level, the third scan signal SC3(n) can have a high level, and the emission control signal EM(n) can have a high level.

In response to the scan signals SC1(n) to SC3(n) and the emission control signal EM(n), the third transistor T3 and the sixth transistor T6 can be turned on, and the first transistor T1, the second transistor T2, the fourth transistor T4, and the fifth transistor T5 can be turned off.

Accordingly, the anode reset voltage Var can be provided to the fourth node N4 by the third transistor T3 in the turned-on state. As a result, the initialization i.e., the anode reset of the anode electrode of the light emitting diode OD can be performed.

Meanwhile, the first node N1 can be electrically short-circuited with the fourth node N4 by the sixth transistor T6 in the turned-on state, so that the anode reset voltage Var can be continuously supplied, and the current path (or charge path) from the first electrode (or source electrode) of the driving transistor DT to the anode electrode of the light emitting diode OD can be initialized i.e., the anode reset can be performed.

At this time, during the anode reset period Tar, at least one of the fifth and sixth transistors T5 and T6 can be turned off, and the connection between the light emitting diode OD and the terminal of the high-potential driving voltage EVDD can be electrically disconnected, so that no current path is formed, and thus the light emitting diode OD can be turned off.

After the anode reset period Tar is completed as above, the emission period Te can be operated again, and during the emission period Te, the driving current can be supplied to the light emitting diode OD to repeat the emission operation.

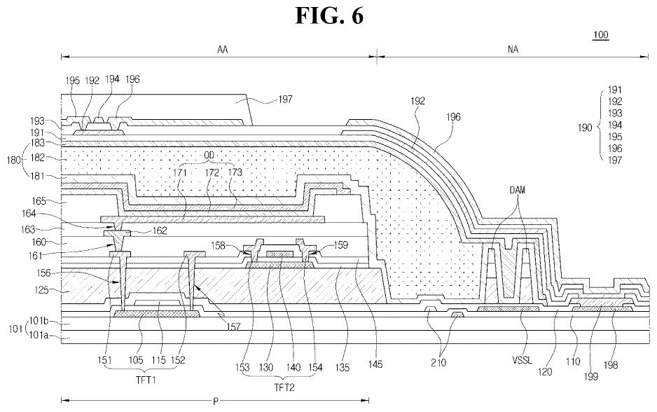

Hereinafter, an example of a cross-sectional structure of the display panel 100 of this embodiment is described with further reference to FIG. 6.

Particularly, FIG. 6 is a cross-sectional view schematically illustrating an example of a cross-sectional structure of a display panel according to the first embodiment of the present disclosure.

Referring to FIG. 6, for convenience of explanation, two thin film transistors TFT1 and TFT2 are illustrated in the pixel P within the display region AA. Here, the thin film transistor TFT1 positioned relatively lower and closer to the substrate 101 is referred to as a first thin film transistor TFT1, which can be a polycrystalline silicon thin film transistor. The thin film transistor TFT2 positioned relatively upper and farther from the substrate 101 is referred to as a second thin film transistor TFT2, which can be an oxide thin film transistor.

The first thin film transistor TFT1 can be a driving transistor (DT of FIG. 2), but not limited thereto. In addition, the second thin film transistor TFT2 can be one of the first to sixth transistors (T1 to T6 of FIG. 2) that are switching thin film transistors, for example, the first transistor (T1 of FIG. 2) connected to the storage capacitor (Cst of FIG. 2), but not limited thereto.

The substrate 101 can be configured as, for example, a thin glass substrate (or glass film) or a plastic substrate (or plastic film) so as to implement a flexible characteristics of the display panel 100.

Here, in a case where the substrate 101 is configured as a glass substrate, for example, the substrate 101 can have a thickness of approximately 0.2 mm.

In a case where the substrate 101 is configured as a plastic substrate, for example, the substrate 101 can include at least one polyimide layer. In this embodiment, the substrate 101 configured of two polyimide layers, which are a first polyimide layer 101a and a second polyimide layer 101b, is taken as an example.

The first thin film transistor TFT1 can include a first semiconductor layer 105 disposed on the substrate 101, a first gate electrode 115 overlapping the semiconductor layer 105 with a first insulating layer 110 interposed therebetween, and a first source electrode 151 and a first drain electrode 152 located on a fourth insulating layer 145 over the first gate electrode 115. Here, the first semiconductor layer 105 can be formed of polycrystalline silicon, but not limited thereto.

The first semiconductor layer 105 can include a central channel region and source and drain regions on both sides thereof. The first source electrode 151 and the first drain electrode 152 can be connected to the source region and the drain region of the first semiconductor layer 105 through the first and second contact holes 156 and 157 that are formed in the insulating layers 110, 120, 125, 135, and 145 located below the first source electrode 151 and the first drain electrode 152.

A second insulating layer 120 can be formed on the first gate electrode 115 of the first thin film transistor TFT1.

A first interlayered insulating layer 125 can be formed on the second insulating layer 120. The second thin film transistor TFT2 can be formed on the first interlayered insulating layer 125.

The second thin film transistor TFT2 can include a second semiconductor layer 130 on the first interlayered insulating layer 125, a second gate electrode 140 overlapping the second semiconductor layer 130 with a third insulating layer 135 interposed therebetween, and a second source electrode 153 and a second drain electrode 154 located on the fourth insulating layer 145 over the second gate electrode 140. Here, the second semiconductor layer 130 can be formed of an oxide semiconductor, but not limited thereto.

The second semiconductor layer 130 can include a central channel region and source and drain regions on both sides thereof. The second source electrode 153 and the second drain electrode 154 can be connected to the source and drain regions of the second semiconductor layer 130 through third and fourth contact holes 158 and 159 formed in the insulating layers 135 and 145 located below the second source electrode 153 and the second drain electrode 154.

The storage capacitor Cst and the auxiliary capacitor Ca can be further disposed on the substrate 101.

The storage capacitor Cst and the auxiliary capacitor Ca can be configured to overlap each other, including an electrode that is common to them.

At least one of the electrodes of the storage capacitor Cst and the auxiliary capacitor Ca can be disposed at the same layer as the second gate electrode 140 of the second thin film transistor TFT2. In this case, the second thin film transistor TFT2 can be the driving transistor DT, but not limited thereto.

A second interlayered insulating layer (or first planarization layer) 160 can be formed on the second thin film transistor TFT2.

Here, the first, second, third, and fourth insulating layers 110, 120, 135, and 145 can be formed of an inorganic insulating material such as silicon nitride or silicon oxide, but not limited thereto.

In addition, the first and second interlayered insulating layers 125 and 160 can be formed of an organic insulating material such as photo acrylic or benzocyclobutene, but not limited thereto.

A connection electrode 162 can be formed on the second interlayered insulating layer 160. The connection electrode 162 can be connected to the first source electrode 151 through a contact hole 161 formed in the second interlayered insulating layer 160.

A third interlayered insulating layer (or second planarization layer) 163 can be formed on the connection electrode 162. The third interlayered insulating layer 163 can be formed of an organic insulating material such as photo acrylic or benzocyclobutene, but not limited thereto.

The light emitting diode OD and a bank 165 can be formed on the third interlayered insulating layer 163.

The light emitting diode OD can include an anode electrode (or first electrode) 171, a light emitting layer 172, and a cathode electrode (or second electrode) 173.

The anode electrode 171 can be connected to the connection electrode 162 through the contact hole 164 formed in the third interlayered insulating layer 163.

The bank 165 can be disposed along a boundary of the pixel P and can be formed to cover an edge of the anode electrode 171. The light emitting layer 172 can be formed on the anode electrode 171 exposed through an opening of the bank 165.

The cathode electrode 173 can be formed on the light emitting layer 172 and can be applied with the low-potential driving voltage (EVSS of FIG. 2).

An encapsulation layer 180 can be formed on the cathode electrode 173. The encapsulation layer 180 can include at least one inorganic encapsulation layer and at least one organic encapsulation layer, but not limited thereto. In this disclosure, a structure of the encapsulation layer 180, in which a first encapsulation layer 181, a second encapsulation layer 182, and a third encapsulation layer 183 are sequentially stacked, is described as an example.

The first encapsulation layer 181 can be formed on the substrate 101 on which the cathode electrode 173 is formed. The third encapsulation layer 183 can be formed on the substrate 101 on which the second encapsulation layer 182 is formed, and can be formed to surround an upper surface, a lower surface, and a side surface of the second encapsulation layer 182 together with the first encapsulation layer 181. The first encapsulation layer 181 and the third encapsulation layer 183 can minimize or prevent external moisture or oxygen from penetrating into the light emitting diode OD. The first encapsulation layer 181 and the third encapsulation layer 183 can be formed of an inorganic insulating material capable of low-temperature deposition, such as silicon nitride, silicon oxide, silicon oxynitride, or aluminum oxide.

The second encapsulation layer 182 can acts as a buffer to relieve stress between layers due to bending of the display apparatus 10, and can flatten steps between layers. The second encapsulation layer 182 can be formed on the substrate 101 on which the first encapsulation layer 181 is formed, using a non-photosensitive organic insulating material such as acrylic resin, epoxy resin, phenolic resin, polyamide resin, polyimide resin, polyethylene, or silicon oxycarbon (SiOC), or a photosensitive organic insulating material such as photo acrylic, but not limited thereto. When the second encapsulation layer 182 is formed through an inkjet method, a dam DAM can be placed in the non-display region NA to prevent the second encapsulation layer 182 in liquid form from spreading to an edge of the substrate 101. The dam DAM can be disposed closer to the edge of the substrate 101 than the second encapsulation layer 182. By the dam DAM, the second encapsulation layer 182 can be prevented from spreading to a pad region, where a conductive pad is disposed, on an outermost edge of the substrate 101.

The dam DAM can be designed to prevent the spreading of the second encapsulation layer 182, but if the second encapsulation layer 182 is formed to exceed a height of the dam DAM during a process, the second encapsulation layer 182 as an organic layer can be exposed to an outside, so that moisture, etc. can easily penetrate into the light emitting element. To prevent this, 10 or more dam DAM can be formed in succession, but not limited thereto.

The dam DAM can be formed simultaneously with the first interlayered insulating layer 125, the second interlayered insulating layer 160, and the third interlayered insulating layer 163. When forming the first interlayered insulating layer 125, a lower layer of the dam DAM can be formed together, and when forming the second and third interlayered insulating layers 160 and 163, an upper layer of the dam DAM can be formed together, so that the dam DAM can be formed in a triple laminated structure. As another example, the dam DAM can be formed with one or two of the first, second, and third interlayered insulating layers 125, 160, and 163.

Accordingly, the dam DAM can be formed of the same material as the first interlayered insulating layer 125, the second interlayered insulating layer 160, and the third interlayered insulating layer 163, but not limited thereto.

The dam DAM can be formed to overlap a low-potential driving voltage line VSSL. For example, the low-potential driving voltage line VSSL can be formed at a lower layer of a region, where the dam DAM is located, in the non-display region NA.

The low-potential driving voltage line VSSL and the gate driving portion 210 configured in the GIP structure can be formed along a periphery of the display panel 100, and the low-potential driving voltage line VSSL can be located outside the gate driving portion 210. In addition, the low-potential driving voltage line VSSL can be connected to the cathode electrode 173 to apply the low-potential driving voltage EVSS. The gate driving portion 210 is simply shown in a planar and cross-sectional manner in the drawings, but can be configured with the same structure as the first thin film transistor TFT1 and/or the second thin film transistor TFT2 of the display region AA.

A touch layer (or touch element layer) 190 can be disposed on the encapsulation layer 180. In the touch layer 190, a touch buffer layer 191 can be positioned between a touch sensor metal including touch electrode connection lines 192 and 194 and touch electrodes 195 and 196, and the cathode electrode 173 of the light emitting diode OD.

The touch buffer layer 191 can block a chemical solution (developer, etchant, etc.) used in a manufacturing process of the touch sensor metal disposed on the touch buffer layer 191 or moisture from the outside from penetrating into the light emitting layer 172 containing an organic material. Accordingly, the touch buffer layer 191 can prevent damage to the light emitting layer 172 that is vulnerable to the chemical solution or moisture.

According to a mutual-capacitance-based touch sensor structure, the touch electrodes 195 and 196 can be disposed on the touch buffer layer 191, and the touch electrodes 195 and 196 can be arranged to cross each other.

The touch electrode connection lines 192 and 194 can electrically connect the touch electrodes 195 and 196. One of the touch electrode connection lines 192 and 194, and the touch electrodes 195 and 196 can be located at different layers with a touch insulation layer 193 interposed therebetween. In addition, one of the touch electrode connection lines 192 and 194 and the other of the touch electrode connection lines 192 and 194 can be located at different layers with the touch insulation layer 193 interposed therebetween.

The touch electrode connection lines 192 and 194 can be arranged to overlap the bank 165, thereby preventing decrease in aperture ratio, but not limited thereto.

A part of the touch electrodes 195 and 196 and a part of the touch electrode connection line 192 can extend along the top and side surfaces of the encapsulation layer 180 and the top and side surfaces of the dam DAM and be electrically connected to a touch driving circuit through a touch pad 198 and 199.

A part of the touch electrodes 195 and 196 and a part of the touch electrode connection line 192 can receive a touch driving signal from the touch driving circuit and transmit it to the touch electrodes 195 and 196, and can transmit a touch sensing signal detected by the touch electrodes 195 and 196 to the touch driving circuit.

In this regard, for example, a driving IC (e.g., data IC, etc.) of the data driving portion 220 including the touch driving circuit can be configured in a COF type and connected to the non-display region NA of the substrate 101 of the display panel 100, and in this case, an end of the touch pad 198 and 199 can be connected to a flexible circuit film on which the driving IC is mounted, so that a signal can be transmitted.

A touch protective layer 197 can be disposed on the touch electrodes 195 and 196. In the drawing, the touch protective layer 197 is shown as being disposed only on the touch electrodes 195 and 196, but not limited thereto, and the touch protective layer 197 can extend before or after the dam DAM to be disposed on the touch electrode connection line 192.

In addition, a color filter can be disposed on the encapsulation layer 180. The color filter can be positioned on the touch layer 190, or between the encapsulation layer 180 and the touch layer 190.

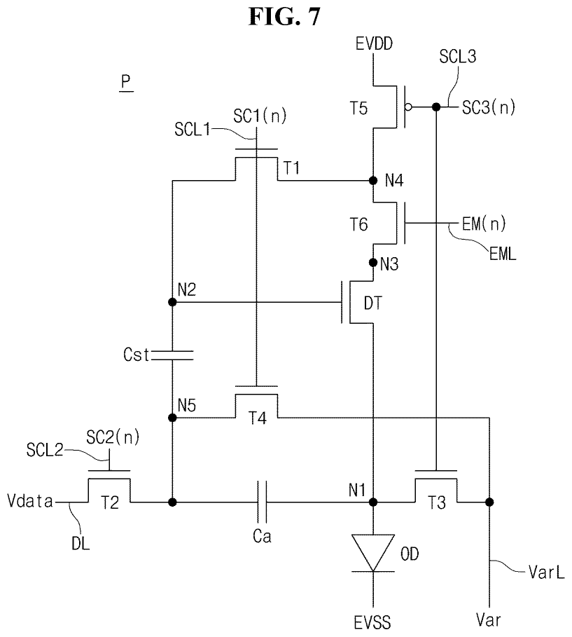

FIG. 7 is a circuit view schematically illustrating a second example of the pixel of the display apparatus according to the first embodiment of the present disclosure.

In the following description, specific explanations of components identical or similar to those of the first embodiment described above can be omitted or may be briefly provided.

Similarly to the first example, in the second example, the sampling period (Tsp of FIG. 4A) for the threshold voltage (Vth) of the driving transistor DT can be set to a considerably long time, separated from the data writing period (Tw of FIG. 4). Accordingly, the threshold voltage (Vth) of the driving transistor DT can be sufficiently sampled during the sampling operation, thereby reducing or preventing an error component in the threshold voltage (Vth) that can occur when sampling for a short period, such as a horizontal period. Therefore, the compensation error of the threshold voltage can be reduced, thereby enhancing the threshold voltage compensation.

Meanwhile, unlike the first example, in the pixel P of the second example, the sixth transistor T6, to which the emission control signal EM(n) is applied, can be configured to be connected between the driving transistor DT and the fifth transistor T5.

In this regard, the sixth transistor T6 can include, for example, a first electrode (or source electrode) connected to the driving transistor DT at the third node N3, a second electrode (or drain electrode) connected to the fifth transistor T5 at the fourth node N4, and a gate electrode receiving the emission control signal EM(n).

With the sixth transistor T6 arranged as described above, the first electrode of the driving transistor DT can be connected to the first node N1 (or the anode electrode of the light emitting diode OD).

The pixel P configured as described above can be driven similarly to the above-described first embodiment. For example, within the non-emission period (Tne of FIG. 4A), the initialization period (Ti of FIG. 4A), the sampling period (Tsp of FIG. 4A), and the data writing period (Tw of FIG. 4A) can be sequentially performed, followed by the emission period (Te of FIG. 4A).

For example, even if the connection position of the sixth transistor T6 is changed compared to the first example, during the initialization period (Ti of FIG. 4), no current path is formed between the terminal of the high-potential driving voltage EVDD and the terminal of the low-potential driving voltage EVSS, and the same effect of preventing current flow can be achieved.

Furthermore, during the sampling period Tsp, the data writing period Tw, and the emission period Te, the display apparatus can operate in the same manner as the first example, the same effect as in the first example can be achieved.

### Second Embodiment

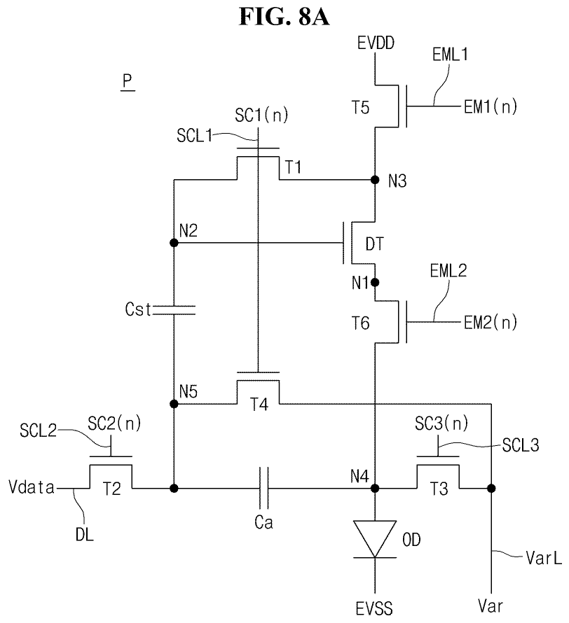

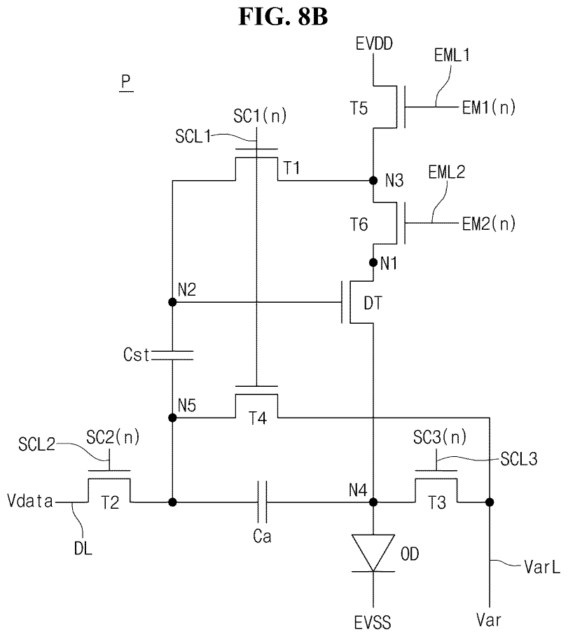

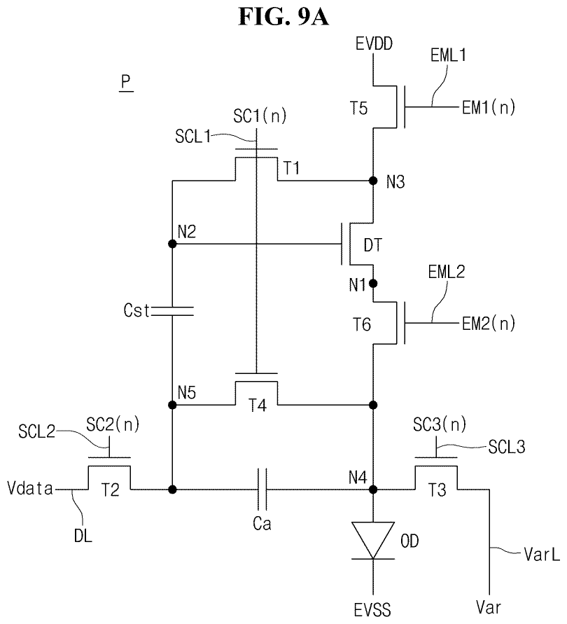

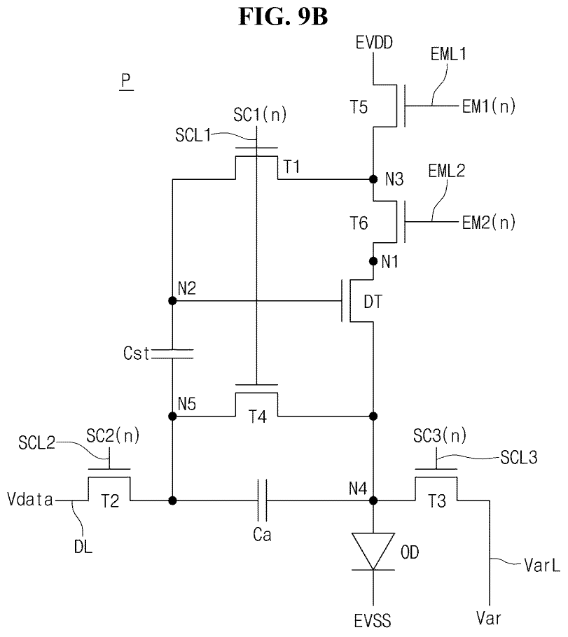

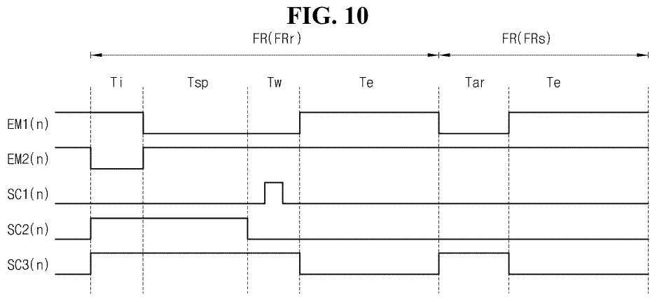

FIG. 8A is a circuit view schematically illustrating a first example of a pixel of a display apparatus according to a second embodiment of the present disclosure. FIG. 8B is a circuit view schematically illustrating a second example of the pixel of the display apparatus according to the second embodiment of the present disclosure. FIG. 9A is a circuit view schematically illustrating a third example of the pixel of the display apparatus according to the second embodiment of the present disclosure. FIG. 9B is a circuit view schematically illustrating a fourth example of the pixel of the display apparatus according to the second embodiment of the present disclosure. FIG. 10 is a timing chart schematically illustrating driving signals for driving the pixels of FIGS. 8A to 9B.

In the following description, detailed explanations of components identical or similar to those of the first embodiment described above can be omitted or may be briefly provided.

The pixels P according to this embodiment can be modifications of the first embodiment. In other words, FIGS. 8A and 9A can be modifications of the pixel P of FIG. 2, and FIGS. 8B and 9B can be modifications of the pixel P of FIG. 7. Each pixel P of any display apparatus in all embodiments of the present disclosure can have the configuration of any pixel P shown in any figure of the present application.

Referring to FIGS. 8A to 10, in the second embodiment, similarly to the first embodiment, the sampling period Tsp for the threshold voltage (Vth) of the driving transistor DT can be set to a considerably long time, separated from the data writing period Tw. Accordingly, the threshold voltage (Vth) of the driving transistor DT can be sufficiently sampled during the sampling operation, so that an error component of the threshold voltage (Vth) that can occur when sampling for a short time, such as a horizontal period, can be reduced or prevented. Therefore, the compensation error of the threshold voltage can be reduced, and the threshold voltage compensation can be enhanced.

Unlike the first embodiment, in the pixels P of the first to fourth examples of this embodiment, the fifth transistor T5 can be configured as an N-type transistor. Accordingly, the circuit structure of the pixels P of this embodiment can be configured with all thin film transistors as N-type transistors.

In this regard, for example, the N-type fifth transistor T5 can be distinct from the third transistor T3 to which the third scan signal SC3(n) is applied, so that fifth transistor T5 can be controlled according to a first emission control signal EM1(n). In addition, the sixth transistor T6 can be controlled by a second emission control signal EM2(n).

In addition, in the pixels P of the third and fourth examples of this embodiment, the fourth transistor T4 may not be directly connected to the reset voltage line VarL, but can be connected to the fourth node N4, so that the fourth transistor T4 can be applied with the anode reset voltage Var through the third transistor T3.

In this regard, for example, when the third transistor T3 is turned on, the fourth transistor T4 can receive the same anode reset voltage Var, so the same effect can be obtained, and the design can be made easier by omitting (or removing) the signal line within the pixel P. As in the first and second examples, in the third and fourth examples, the N-type fifth transistor T5 can be controlled according to the first emission control signal EM1(n) and can be distinguished from the third transistor T3. However, this embodiment is not limited thereto, and depending on the design, the fifth transistor T5 can be configured as a P type as in the first embodiment and controlled by the third scan signal SC3(n).

Since the fifth transistor T5 can be controlled separately from the third transistor T3, the third scan signal SC3(n) controlling the third transistor T3 can be applied while being fixed to a high-level voltage, without swinging between high and low levels, during the initialization period Ti, and the third scan signal SC3(n) can be applied as a high-level voltage until the sampling period Tsp and the data writing period Tw. Accordingly, both ends of the auxiliary capacitor Ca can be initialized, and the anode electrode of the light emitting diode OD can be continuously supplied with the anode reset voltage Var until the emission period Te, so that the light emitting diode OD can emit light at a desired luminance without distortion. In addition, the first emission control signal EM1(n) can be applied as a low level voltage in the sampling period Tsp and the data writing period Tw, so that a current path may not be formed between the terminal of the high-potential driving voltage EVDD and the terminal of the low-potential driving voltage EVSS. In addition, the third scan signal SC3(n) can be applied as a high-level voltage in the anode reset period Tar, so that the light emitting diode OD may not emit light.

### Third Embodiment

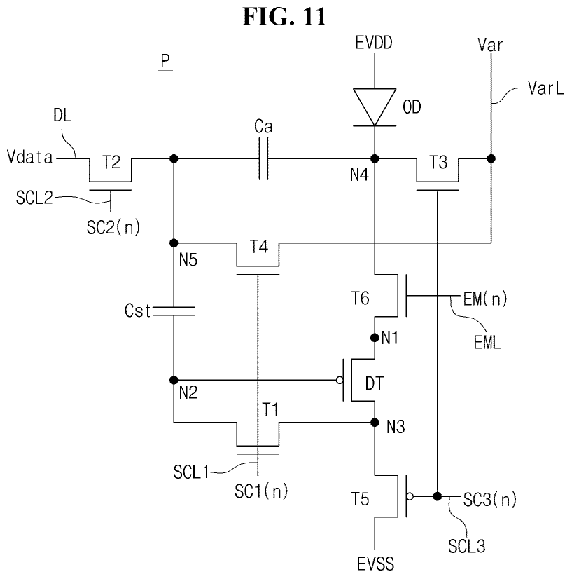

FIG. 11 is a circuit view schematically illustrating a pixel of a display apparatus according to a third embodiment of the present disclosure.

In the following description, detailed explanations of components identical to or similar to those of the first embodiment described above can be omitted or may be briefly provided.

Referring to FIG. 11, in this embodiment, similarly to the first embodiment, the sampling period (Tsp of FIG. 4A) for the threshold voltage (Vth) of the driving transistor DT can be set to a considerably long time, separated from the data writing period (Tw of FIG. 4A). Accordingly, the threshold voltage (Vth) of the driving transistor DT can be sufficiently sampled during the sampling operation, so that an error component of the threshold voltage (Vth) that can occur when sampling for a short time, such as a horizontal period, can be reduced or prevented. Therefore, the compensation error of the threshold voltage can be reduced, and the threshold voltage compensation can be enhanced.

Unlike the first embodiment, in the pixel P of this embodiment, the driving transistor DT can be configured as a P-type transistor. Accordingly, the circuit structure of the pixel P of this embodiment can have a form reversed from the circuit structure of the pixel P of the first embodiment.

In this regard, for example, the P-type driving transistor DT can be electrically connected to the light emitting diode OD through the first node N1, and more specifically, to the cathode electrode (or first electrode) of the light emitting diode OD through the sixth transistor T6. In this case, the anode electrode (or second electrode) of the light emitting diode OD can be configured to receive the high-potential driving voltage EVDD.

The first transistor T1 to the sixth transistor T6 within the pixel P can be configured as N-type transistors, but not limited thereto.

In this case, the connection relationship between the driving transistor DT, the first to sixth transistors T1 to T6, the storage capacitor Cst, and the auxiliary capacitor Ca can be similar to the connection relationship in the first embodiment.

For example, the first transistor T1 can be connected between the second node N2 and the third node T3. The second transistor T2 can be connected between the fifth node N5 and the data line DL. The third transistor T3 can be connected between the fourth node N4 and the reset voltage line VarL. The fourth transistor T4 can be connected between the fifth node N5 and the reset voltage line VarL. The fifth transistor T5 can be connected to the third node N3 and receive the low-potential driving voltage EVSS. The sixth transistor T6 can be connected between the first node N1 and the fourth node N4.

The storage capacitor Cst can be connected between the second node N2 and the fifth node N5. The auxiliary capacitor Ca can be connected between the fourth node N4 and the fifth node N5.

As described above, the features and advantages of the embodiments of the present disclosure can be provided as follows.

The sampling period for the threshold voltage of the driving transistor can be set to a considerably long time, separated from the data writing period.

Therefore, the threshold voltage of the driving transistor can be sufficiently sampled during the sampling operation, so that an error component of the threshold voltage that can occur when sampling for a short time, such as a horizontal period, can be reduced or prevented.

Furthermore, the threshold voltage of the driving transistor can be stored in the storage capacitor according to the sampling operation, and the storage capacitor can be connected in series with the auxiliary capacitor to which the data voltage is applied, so that a more accurate compensation value can be derived.

Therefore, the compensation error of the threshold voltage can be reduced, thus the threshold voltage compensation can be improved, and consequently, the image quality of the display apparatus can be improved.

A display apparatus according to an embodiment of the present disclosure can include a display panel including a display region in which pixels are arranged and a non-display region surrounding the display region, a data driving portion configured to apply data voltages to the pixels, and at least one gate driving portion configured to applying scan signals and emission control signals to the pixels, wherein one or each of the pixels includes a light emitting element including an anode electrode, a cathode electrode, and a light emitting layer between the anode electrode and the cathode electrode, a driving transistor configured to supply a driving current to the light emitting element and including an oxide semiconductor layer, and a first capacitor and a second capacitor connected in series to a gate electrode of the driving transistor, and wherein the first capacitor is configured to store a threshold voltage of the driving transistor, and the second capacitor is configured to store the data voltage.

In a display apparatus according to an embodiment of the present disclosure, the second capacitor is connected between the first capacitor and the light emitting element.

In a display apparatus according to an embodiment of the present disclosure, the first capacitor and the second capacitor include an electrode that is common thereto, and overlap each other.

In a display apparatus according to an embodiment of the present disclosure, at least one of electrodes of the first capacitor or the second capacitor is disposed at a same layer as the gate electrode of the driving transistor.

In a display apparatus according to an embodiment of the present disclosure, one or each of the pixels further includes a first node connected to a first electrode of the driving transistor, a second node connected to the gate electrode of the driving transistor, a third node connected to a second electrode of the driving transistor, a fourth node connected to the anode electrode of the light emitting element, a fifth node to which the first capacitor and the second capacitor are connected, a first transistor configured to be turned on in response to a first scan signal to form a diode connection with the driving transistor, a second transistor configured to apply the data voltage to the fifth node in response to a second scan signal, and a third transistor configured to apply an anode reset voltage to the fourth node in response to a third scan signal.

In a display apparatus according to an embodiment of the present disclosure, one or each of the pixels further includes a fourth transistor configured to apply the anode reset voltage to the fifth node in response to the first scan signal, a fifth transistor configured to apply a high-potential driving voltage to the third node in response to the third scan signal, and a sixth transistor configured to electrically connect the first node to the fourth node in response to an emission control signal.

In a display apparatus according to an embodiment of the present disclosure, the third transistor and the fifth transistor are configured to be controlled by a same signal, and are configured to have turn-on timings that are in opposite phases.

In a display apparatus according to an embodiment of the present disclosure, the first transistor and the fourth transistor are configured to be controlled by a same signal, and are configured to be turned on simultaneously.

In a display apparatus according to an embodiment of the present disclosure, a drain electrode of the fourth transistor is connected to a drain electrode of the third transistor.

In a display apparatus according to an embodiment of the present disclosure, a drain electrode of the fourth transistor is connected to the anode electrode of the light emitting element.

In a display apparatus according to an embodiment of the present disclosure, one or each of the pixels further includes a fourth transistor configured to apply the anode reset voltage to the fifth node in response to the first scan signal, a fifth transistor configured to apply a high-potential driving voltage to the third node in response to a first emission control signal, and a sixth transistor configured to electrically connect the first node to the fourth node in response to a second emission control signal, and wherein the driving transistor and the first to sixth transistors are all N-type transistors.

In a display apparatus according to an embodiment of the present disclosure, the first emission control signal is configured to be in reverse phase with the third scan signal.

In a display apparatus according to an embodiment of the present disclosure, a source electrode of the driving transistor and the anode electrode of the light emitting element are directly connected to each other.

In a display apparatus according to an embodiment of the present disclosure, the pixel is configured to operate with an initialization period in which an anode reset voltage is applied, a sampling period in which the threshold voltage of the driving transistor is sampled, a data writing period in which the data voltage is applied, and an emission period in which a driving current is supplied to the light emitting element.

In a display apparatus according to an embodiment of the present disclosure, during the initialization period, at least one end of the first capacitor and the second capacitor is configured to be applied with the anode reset voltage.

In a display apparatus according to an embodiment of the present disclosure, during at least a portion of the initialization period, both ends of the second capacitor is configured to be applied with the anode reset voltage.

In a display apparatus according to an embodiment of the present disclosure, during the sampling period, the first capacitor is configured to store the threshold voltage of the driving transistor.

In a display apparatus according to an embodiment of the present disclosure, during the data writing period, the second capacitor is configured to store a difference between the data voltage and the anode reset voltage.

In a display apparatus according to an embodiment of the present disclosure, the gate driving portion is arranged to include a plurality of scan driving circuits and at least one emission driving circuit which are in the non-display region on each of both sides of the display region.

In a display apparatus according to an embodiment of the present disclosure, the at least one emission driving circuit is arranged between the plurality of scan driving circuits.

In a driving method for a display apparatus according to an embodiment of the present disclosure, the display apparatus can include a display panel including a display region in which pixels are arranged and a non-display region surrounding the display region, a data driving portion configured to apply data voltages to the pixels, and at least one gate driving portion configured to applying scan signals and emission control signals to the pixels, wherein one or each of the pixels includes a light emitting element including an anode electrode, a cathode electrode, and a light emitting layer between the anode electrode and the cathode electrode, a driving transistor configured to supply a driving current to the light emitting element and including an oxide semiconductor layer, and a first capacitor and a second capacitor connected in series to a gate electrode of the driving transistor, and wherein the first capacitor is configured to store a threshold voltage of the driving transistor, and the second capacitor is configured to store the data voltage, wherein a sampling period in which the threshold voltage of the driving transistor is sampled is separated from a data writing period in which the data voltage is applied, so that the threshold voltage of the driving transistor is sufficiently sampled during the sampling period.

In a driving method according to an embodiment of the present disclosure, one or each of the pixels is configured to operate sequentially with an initialization period in which an anode reset voltage is applied, the sampling period in which the threshold voltage of the driving transistor is sampled, the data writing period in which the data voltage is applied, and an emission period in which a driving current is supplied to the light emitting element.

In a driving method according to an embodiment of the present disclosure, the sampling period is set longer than the data writing period.

In a driving method according to an embodiment of the present disclosure, the sampling period is set to be equal to or more than twice the data writing period.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

What is claimed is:

1. A display apparatus, comprising:
a display panel including a display region in which pixels are arranged and a non-display region adjacent to the display region;
a data driving portion configured to apply data voltages to the pixels; and
at least one gate driving portion configured to apply scan signals and emission control signals to the pixels,
wherein one of the pixels includes:
a light emitting element including an anode electrode, a cathode electrode, and a light emitting layer between the anode electrode and the cathode electrode;
a driving transistor configured to supply a driving current to the light emitting element and including an oxide semiconductor layer; and
a first capacitor and a second capacitor connected in series to a gate electrode of the driving transistor, and
wherein the first capacitor is configured to store a threshold voltage of the driving transistor, and the second capacitor is configured to store a data voltage among the data voltages.

2. The display apparatus of claim 1, wherein the second capacitor is connected between the first capacitor and the light emitting element.

3. The display apparatus of claim 2, wherein the first capacitor and the second capacitor include an electrode that is common thereto, and overlap each other.

4. The display apparatus of claim 2, wherein at least one of electrodes of the first capacitor or the second capacitor is disposed at a same layer as the gate electrode of the driving transistor.

5. The display apparatus of claim 1, wherein the one of the pixels further includes:
a first node connected to a first electrode of the driving transistor;
a second node connected to the gate electrode of the driving transistor;
a third node connected to a second electrode of the driving transistor;
a fourth node connected to the anode electrode of the light emitting element;
a fifth node to which the first capacitor and the second capacitor are connected;
a first transistor configured to be turned on in response to a first scan signal to form a diode connection with the driving transistor;
a second transistor configured to apply the data voltage to the fifth node in response to a second scan signal; and
a third transistor configured to apply an anode reset voltage to the fourth node in response to a third scan signal.

6. The display apparatus of claim 5, wherein the one of the pixels further includes:
a fourth transistor configured to apply the anode reset voltage to the fifth node in response to the first scan signal;
a fifth transistor configured to apply a high-potential driving voltage to the third node in response to the third scan signal; and
a sixth transistor configured to electrically connect the first node to the fourth node in response to an emission control signal.

7. The display apparatus of claim 6, wherein the third transistor and the fifth transistor are configured to be controlled by a same signal, and are configured to have turn-on timings that are in opposite phases.

8. The display apparatus of claim 6, wherein the first transistor and the fourth transistor are configured to be controlled by a same signal, and are configured to be turned on simultaneously.

9. The display apparatus of claim 6, wherein a drain electrode of the fourth transistor is connected to a drain electrode of the third transistor.

10. The display apparatus of claim 6, wherein a drain electrode of the fourth transistor is connected to the anode electrode of the light emitting element.

11. The display apparatus of claim 5, wherein the one of the pixels further includes:
a fourth transistor configured to apply the anode reset voltage to the fifth node in response to the first scan signal;
a fifth transistor configured to apply a high-potential driving voltage to the third node in response to a first emission control signal; and
a sixth transistor configured to electrically connect the first node to the fourth node in response to a second emission control signal, and
wherein the driving transistor and the first to sixth transistors are all N-type transistors.

12. The display apparatus of claim 11, wherein the first emission control signal is configured to be in reverse phase with the third scan signal.

13. The display apparatus of claim 1, wherein a source electrode of the driving transistor and the anode electrode of the light emitting element are directly connected to each other.

14. The display apparatus of claim 1, wherein the one of the pixels is configured to operate with:
an initialization period in which an anode reset voltage is applied;
a sampling period in which the threshold voltage of the driving transistor is sampled;
a data writing period in which the data voltage is applied; and
an emission period in which a driving current is supplied to the light emitting element.

15. The display apparatus of claim 14, wherein during the initialization period, at least one end of the first capacitor and the second capacitor is configured to be applied with the anode reset voltage.

16. The display apparatus of claim 14, wherein during at least a portion of the initialization period, ends of the second capacitor are configured to be applied with the anode reset voltage.

17. The display apparatus of claim 14, wherein during the sampling period, the first capacitor is configured to store the threshold voltage of the driving transistor.

18. The display apparatus of claim 14, wherein during the data writing period, the second capacitor is configured to store a difference between the data voltage and the anode reset voltage.

19. The display apparatus of claim 1, wherein the gate driving portion is arranged to include a plurality of scan driving circuits and at least one emission driving circuit, which are in the non-display region on each of sides of the display region.

20. The display apparatus of claim 19, wherein the at least one emission driving circuit is arranged between the plurality of scan driving circuits.
